(19) United States
(12) Patent Application Publication
(10) Pub. No.: US 2026/0296257 A1
(43) Pub. Date: Oct. 1, 2026

(54) POWER TRANSACTION SYSTEM AND POWER TRANSACTION METHOD

(71) Applicant: HONDA MOTOR CO., LTD., Tokyo (JP)

(72) Inventors: Yako Takahashi, Tokyo (JP); Tsubasa Watakabe, Tokyo (JP); Thomas Stephen Pontefract, Tokyo (JP); Yohei Katori, Tokyo (JP); Daisuke Inoue, Tokyo (JP); Shinya Yasuhara, Tokyo (JP)

(21) Appl. No.: 19/463,169

(22) Filed: Jan. 29, 2026

(30) Foreign Application Priority Data
Mar. 26, 2025 (JP) 2025-050961

(51) Int. Cl. B60L 53/66; B60L 53/68; B60L 55/00; G06Q 50/06

(52) U.S. Cl. CPC B60L 53/665; B60L 53/68; B60L 55/00; G06Q 50/06; B60L 2250/16

(57) ABSTRACT

A power transaction system includes: an acquisition unit configured to acquire power transaction information indicating a user's power transaction; a calculation unit configured to calculate a cumulative remuneration on the basis of the power transaction information; and a display control unit configured to generate display information on the basis of a degree of participation in the power transaction based on the power transaction information and the cumulative remuneration and to transmit the display information to the user's terminal. The display information includes a graphical object. The terminal presents the display information to the user.

### CROSS-REFERENCE TO RELATED APPLICATION

Priority is claimed on Japanese Patent Application No. 2025-050961, filed Mar. 26, 2025, the content of which is incorporated herein by reference.

### BACKGROUND OF THE INVENTION

### Field of the Invention

The present invention relates to a power transaction system and a power transaction method.

### Description of Related Art

Demand response (DR) represents a system that reduces power demand or creates power demand on the basis of an amount of power demanded and an amount of power supplied and adjusts demand and supply of power. Patent Document 1 discloses a power transaction system that allows a user to determine power operation details of a battery installed in a vehicle on the basis of a power transaction price and performs charging/discharging of the battery.

[Patent Document 1] Japanese Unexamined Patent Application, First Publication No. 2021-149331

### SUMMARY OF THE INVENTION

However, the power transaction system disclosed in Patent Document 1 has a problem in that cumulative operational results in power transactions are not visualized after a user has determined power operation details.

An aspect of the present invention was made in consideration of the aforementioned circumstances, and an objective thereof is to provide a power transaction system and a power transaction method that can visualize cumulative operational results in a user's power transactions.

The present invention employs the following configurations in order to achieve the aforementioned objective.
(1) A power transaction system according to an aspect of the present invention includes: an acquisition unit configured to acquire power transaction information indicating a user's power transaction; a calculation unit configured to calculate a cumulative remuneration on the basis of the power transaction information; and a display control unit configured to generate display information on the basis of a degree of participation in the power transaction based on the power transaction information and the cumulative remuneration and to transmit the display information to the user's terminal, wherein the display information includes a graphical object, and the terminal presents the display information to the user.
(2) In the aspect of (1), the power transaction information may include the number of transactions, the degree of participation may be calculated on the basis of the number of transactions, and the display information may change according to the degree of participation.
(3) In the aspect of (2), the power transaction information may further include at least one of a transaction date and time, an amount of power traded, a transaction price per unit wattage, successive transaction days, attribute information, and additional remuneration, and the display information may change according to the power transaction information.
(4) In the aspect of (1) or (2), the display information may be generated on the basis of the degree of participation multiplied by a first weight and the cumulative remuneration multiplied by a second weight, and the first weight may be different from the second weight.
(5) In the aspect of (3), the attribute information may include information indicating whether the user's operation schedule has changed on the basis of the power transaction, and a predetermined value may be added to the additional remuneration when the operation schedule has changed.
(6) In the aspect of (3), the attribute information may include a request from at least one of a country, a local government, an administrative organization, a corporation aggregate, a general company, and a power company, and a predetermined value may be added to the additional remuneration when the user has performed the power transaction in response to the request.
(7) In the aspect of (3), a predetermined value may be added to the additional remuneration when the number of successive transaction days is equal to or greater than a predetermined number of days.
(8) In the aspect of (3), a predetermined value may be added to the additional remuneration according to the number of other users when the user shares the display information with the other users.
(9) In the aspect of (8), another predetermined value may be added to the additional remuneration when the other users have performed a power transaction on the basis of the display information from the user.
(10) In the aspect of (1) or (2), the object in the display information may express the degree of participation or the cumulative remuneration in a stepwise manner.
(11) In the aspect of (10), the object may include at least one of a building, a structure, a vehicle, an aircraft, a plant, and an animal, and at least one of a size, a shape, a color, a number, a type, and emitted sound of the object may change on the basis of the degree of participation or the cumulative remuneration.
(12) A power transaction method according to another aspect of the present invention includes: an acquisition step of acquiring power transaction information indicating a user's power transaction; a calculation step of calculating a cumulative remuneration on the basis of the power transaction information; and a display control step of generating display information on the basis of a degree of participation in the power transaction based on the power transaction information and the cumulative remuneration and transmitting the display information to the user's terminal, wherein the display information includes a graphical object, and the terminal presents the display information to the user.
According to the aspects of (1) and (12), it is possible to visualize a user's operation result in a DR power transaction.
According to the aspect of (2), it is possible to visualize a user's operation result on the basis of the number of transactions.
According to the aspect of (3), it is possible to visualize a user's operation result using a plurality of elements.
According to the aspect of (4), it is possible to visualize a user's operation result on the basis of power transaction information in addition to a cumulative remuneration.

According to the aspect of (5), a user's operation result is evaluated according to a user's operation of which a schedule has been changed according to a DR plan.

According to the aspect of (6), a user's operation result is evaluated according to a user's operation based on a DR plan.

According to the aspect of (7), it is possible to motivate a user to participate continuously in DR power transactions.

According to the aspect of (8), it is possible to motivate a user to participate in DR power transactions along with other users.

According to the aspect of (9), it is possible to motivate other users to participate in power transactions by sharing power transaction information.

According to the aspect of (10), it is possible to stepwise visualize a user's operation result.

According to the aspect of (11), it is possible to visualize a user's operation result according to the user's taste.

### BRIEF DESCRIPTION OF THE DRAWINGS

FIG. 1 is a diagram schematically illustrating an example of a configuration of a power transaction system including a power transaction device according to an embodiment.

FIG. 2 is a functional block diagram illustrating an example of a configuration of a terminal device according to the embodiment.

FIG. 3 is a diagram illustrating an example of power transaction information according to the embodiment.

FIG. 4 is a flowchart illustrating an example of a process flow in the power transaction system according to the embodiment.

FIG. 5 is a diagram illustrating an example of display information which is displayed on the terminal device according to the embodiment.

FIG. 6 is a diagram illustrating an example of a transition of display information displayed on the terminal device according to the embodiment.

FIG. 7 is a diagram illustrating an example of a transition of display information displayed on the terminal device according to the embodiment.

FIG. 8 is a diagram illustrating an example of a transition of display information displayed on the terminal device according to the embodiment.

FIG. 9 is a diagram illustrating an example of a transition of display information displayed on the terminal device according to the embodiment.

### DETAILED DESCRIPTION OF THE INVENTION

Hereinafter, a power transaction system and a power transaction method according to an embodiment of the present invention will be described with reference to the accompanying drawings.

### Entire Configuration

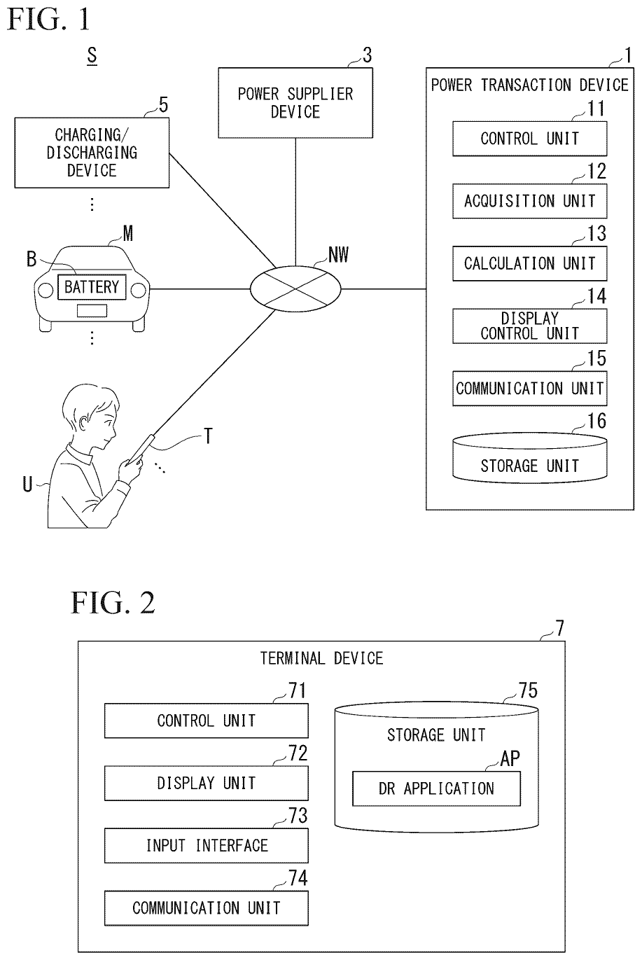

FIG. 1 is a diagram schematically illustrating an example of a configuration of a power transaction system S including a power transaction device 1 according to an embodiment. A power transaction system S includes a power transaction device 1, a power supplier device 3, one or more charging/discharging devices 5, one or more terminal devices 7, one or more vehicles M, and a network NW. The power transaction system S is a system that adjusts and controls power demand and power supply between the charging/discharging device 5 and another device (not illustrated) on the basis of a demand-response plan (hereinafter referred to as a “DR plan”) transmitted for the power supplier device 3. That is, the power transaction system S is an example of a demand-response (DR) system. The network NW is, for example, the Internet, a mobile communication network, a wide area network (WAN), a local area network (LAN), or a cellular network.

The power transaction device 1 is an information processing device and may be, for example, a personal computer, a workstation, a hardware server, or a software server. When the power transaction device 1 is a hardware server, the power transaction device 1 may be, for example, a network server or a cloud server. The power transaction device 1 is communicatively connected to the power supplier device 3, the charging/discharging device 5, the terminal device 7, and the vehicle M via the network NW. When the power transaction device 1 is a software server, the power transaction device 1 may be, for example, server software or a server program.

When the power transaction device 1 is constituted by hardware, the power transaction device 1 includes a central processing unit (CPU), a read only memory (ROM), a random access memory (RAM), a storage device, an input/output interface (IF), and a communication IF. The CPU, the ROM, the RAM, the storage device, the input/output IF, and the communication IF are communicatively connected to each other via a bus.

The power transaction device 1 controls the power transaction system S as a whole. For example, the power transaction device 1 can receive a DR plan from the power supplier device 3 and control charging/discharging of a battery B mounted in the vehicle M connected to the charging/discharging device 5.

The power supplier device 3 is an information processing device and may be, for example, a personal computer, a workstation, a hardware server, or a software server. When the power supplier device 3 is a hardware server, the power supplier device 3 may be, for example, a network server or a cloud server. The power supplier device 3 is communicatively connected to the power transaction device 1, the charging/discharging device 5, the terminal device 7, and the vehicle M via the network NW. When the power supplier device 3 is a software server, the power supplier device 3 may be, for example, server software or a server program. When the power supplier device 3 is constituted by hardware, the power supplier device 3 may have a hardware configuration equal or similar to the power transaction device 1.

A power supplier such as a power transmission and distribution company or a retail power supplier makes a DR plan based on a power generation situation or a power storage situation via the power supplier device 3 and notifies power consumers such as companies or homes on the basis of the DR plan. In the power transaction system S, the power supplier device 3 transmits the DR plan to the power transaction device 1 via the network NW.

The charging/discharging device 5 (also referred to as a “charging/discharging facility”) performs charging and discharging of the battery B mounted on the vehicle M. The charging/discharging device 5 is installed, for example, at an abode of a user U of the vehicle M or at public charging stations. The charging/discharging device 5 performs charging of the battery B using grid energy supplied from a general distribution line network (a grid, a commercial power supply) or using regenerable energy generated by a power generator installed at an abode or the like. The charging/discharging device 5 performs discharging of the battery B by returning power stored in the battery B to the grid.

The vehicle M is a vehicle with four wheels, two wheels, three wheels, or the like and includes a battery B. The vehicle M may be, for example, an electric vehicle, a hybrid vehicle, or a motorbike. A drive source of the vehicle M is, for example, an electric motor or a combination of an electric motor with an internal combustion engine such as a diesel engine or a gasoline engine. The electric motor operates using electric power discharged from the battery B which is a second battery or a fuel cell or using electric power generated by a power generator connected to the internal combustion engine.

The user U is an owner of the vehicle M or a person related to the owner. For example, the user U may be an owner of the vehicle M or a family member of the owner. The user U may be an employee belonging to a company. When the user U returns to an abode thereof, the user U connects (fits) a charging plug of a charging/discharging device 5 provided at the abode to a charging port of the vehicle M, whereby charging and discharging of the vehicle M becomes possible. Alternatively, the user U may go to a charging station and connect (fit) a charging plug of a charging/discharging device 5 provided at the charging station to the charging port of the vehicle M, whereby charging and discharging of the vehicle M becomes possible. When the user U is an employee belonging to a company, the user U connects (fits) a charging plug of a charging/discharging device 5 provided at a business place or the like to the charging port of the vehicle M, whereby charging and discharging of the vehicle M becomes possible. The user U may be an individual or include a plurality of persons.

The terminal device 7 is an information processing device which is used by the user U and may be, for example, a personal computer, a laptop computer, a tablet computer, a smartphone, or a mobile phone. The terminal device 7 is communicatively connected to the power transaction device 1, the power supplier device 3, the charging/discharging device 5, and the vehicle M via the network NW. The terminal device 7 may be communicatively connected directly to the charging/discharging device 5 or the vehicle M. The terminal device 7 may be connected to the vehicle M and serve as an onboard device.

The terminal device 7 includes a CPU, a ROM, a RAM, a storage device, an input/output IF, and a communication IF. The CPU, the ROM, the RAM, the storage device, the input/output IF, and the communication IF are communicatively connected to each other via a bus.

The terminal device 7 transmits information input by the user U to the power transaction device 1, the power supplier device 3, the charging/discharging device 5, the vehicle M, or the like. The terminal device 7 displays information transmitted from the power transaction device 1, the power supplier device 3, the charging/discharging device 5, the vehicle M, or the like on a display or the like provided in the terminal device 7 to notify the user U of the information.

The terminal device 7 can execute a demand response application (hereinafter referred to as a “DR application”) and realize a function of a power transaction or the like. The DR application may be installed in the terminal device 7 in advance or may be installed in the terminal device 7 when the user U performs a power transaction or the like. In a web site or the like provided by the power transaction device 1 or the power supplier device 3, the DR application may be realized using a general-purpose application program. The user U can perform demand response control (hereinafter referred to as “DR control”) by communicating with the power transaction device 1 via the terminal device 7 and supplying power of the power transaction system S or the battery B mounted in the vehicle M to a power grid.

### Functions of Power Transaction Device 1

The power transaction device 1 includes a control unit 11, an acquisition unit 12, a calculation unit 13, a display control unit 14, a communication unit 15, and a storage unit 16. The functional units of the power transaction device 1 can be realized, for example, by causing the CPU in the power transaction device 1 to execute a program stored in the storage device or the like. Some or all of the functional units included in the power transaction device 1 may be realized by hardware such as a large scale integration (LSI) circuit, an application-specific integrated circuit (ASIC), a field-programmable gate array (FPGA), a graphics processing unit (GPU), or a system on chip (SOC) or may be cooperatively realized by software and hardware. The power transaction device 1 is not limited to a single device. For example, the power transaction device 1 may include a plurality of devices, and the plurality of devices may realize the functional units of the power transaction device 1 in cooperation.

The control unit 11 controls the functional units of the power transaction device 1 and manages transmission and reception of data between the functional units of the power transaction device 1, processing procedures, and transmission reception of data between the power transaction device 1 and another device, and the like.

The acquisition unit 12 acquires information on a power transaction or the like from a device or the like included in the power transaction system S or a device or the like not included in the power transaction system S. The acquisition unit 12 acquires information on a DR plan (hereinafter referred to as “DR plan information”) transmitted from the power supplier device 3. For example, the DR plan information may include information indicating that a power supplier buys power at a predetermined transaction price per unit wattage between one date and time and another date and time. The DR plan information may include information such as a power saving request, a power selling request, or a power buying request from a country, a local government, an administrative organization, a corporation aggregate, a general company such as a special wholesale supplier, a power company, or the like. The special wholesale supplier is a supplier that ensures power demand and power supply between a power company and power consumers. The general company includes power transmission or distribution companies and power retailers.

The acquisition unit 12 acquires input information of the user U transmitted from the terminal device 7. For example, the input information may include information indicating that the user U sells a predetermined amount of power between one date and time and another date and time. The input information may include information indicating that the user U sells power in response to a request included in the DR plan information or the like.

The acquisition unit 12 may acquire information indicating connection of the vehicle M to the charging/discharging device 5, an amount of power dischargeable and an amount of power chargeable of the battery B mounted in the vehicle M, and a vehicle type, a model, and a residual fuel capacity of the vehicle M from the charging/discharging device 5. The acquisition unit 12 may acquire information on an operation schedule such as a schedule of the user U from the terminal device 7 under the approval of the user U.

The acquisition unit 12 can acquire an amount of power discharged from the battery B and an amount of power charged in the battery B from the power supplier device 3 or the charging/discharging device 5. The acquisition unit 12 can acquire a date and time of charging/discharging and a transaction price per unit wattage at that date and time. The acquisition unit 12 can correlate the DR plan information acquired from the power supplier device 3, the charging/discharging device 5, and the terminal device 7 with information on a relevant power transaction (hereinafter referred to as “power transaction information”) and store the correlated information in the storage unit 16. The acquisition unit 12 is an example of an “acquisition unit.”

The calculation unit 13 calculates a result of the user U in the power transaction. The calculation unit 13 calculates a remuneration on the basis of the power transaction information acquired from the power supplier device 3, the charging/discharging device 5, and the terminal device 7 and stores the calculated remuneration in the storage unit 16. For example, the calculation unit 13 calculates the remuneration by multiplying the amount of power discharged from the battery B by the transaction price per unit wattage. When the user U performs a power transaction and pays a system fee or the like to a businessman of the power supplier device 3, the calculation unit 13 may calculate a remuneration by subtracting the system fee from the remuneration. The calculation unit 13 calculates a cumulative remuneration by adding the calculated remuneration to the remuneration acquired in the past by the user U. When the user U is an individual, the calculation unit 13 calculates a cumulative remuneration for the individual. When the user U includes a plurality of persons, the calculation unit 13 may calculate a cumulative remuneration for each of the plurality of persons or may calculate a total cumulative remuneration for the plurality of persons. The calculation unit 13 is an example of a “calculation unit.”

The display control unit 14 generates information to be presented to the user U on the basis of the result in the power transaction. The display control unit 14 generates display information on the basis of the power transaction information and the cumulative remuneration. For example, the display control unit 14 generates a three-dimensional model of a street. As the cumulative remuneration increases, the three-dimensional model of a street may be more developed. As the number of power transactions for the user U increases, the three-dimensional model of a street may be more developed. When the user U performs a power transaction according to the DR Plan, the three-dimensional model of a street may be more developed. When the power transaction for the user U is successive in predetermined days or more, the three-dimensional model of a street may be more developed. When a schedule made in advance by the user U has changed according to the DR plan or the like, the three-dimensional model of a street may be more developed.

That is, when the user U performs an operation for the power transaction, the three-dimensional model of a street can be developed. The display control unit 14 transmits the display information to the terminal device 7 via the communication unit 15. The three-dimensional model generated by the display control unit 14 is not limited to a model of a street. For example, the display control unit 14 may generate a model of a park including rides, may generate a model of an individual room including furniture, or may generate a model of a gallery including works of art. When the display control unit 14 generates a model of a gallery including works of art and the user U performs an operation for the power transaction, an object of a work of art such as a painting, a sculpture, or an objet may be added. By describing a list of works of art in a pictorial book, the user U can collect objects of the works of arts to be described in the pictorial book via the power transaction.

When a web site or the like provided by the power transaction device 1 or the power supplier device 3 presents the display information to the user U using a general-purpose application program, the display control unit 14 may store the display information in the storage unit 16 of the power transaction device 1 or transmit the display information to the power supplier device 3. The display control unit 14 is an example of a “display control unit.”

The communication unit 15 performs data communication between the power transaction device 1 and another device by wired communication or wireless communication. The communication unit 15 receives power transaction information from the power supplier device 3, the charging/discharging device 5, and the terminal device 7 and transmits the received power transaction information to the acquisition unit 12. The communication unit 15 receives display information from the display control unit 14 and transmits the display information to the terminal device 7. The terminal device 7 can present a part or the whole of the power transaction information to the user U on the basis of the display information received from the display control unit 14 via the communication unit 15.

The storage unit 16 stores power transaction information or the like transmitted or received by the power transaction device 1. The storage unit 16 may be a part of the storage device provided in the power transaction device 1 or may be a storage device which is provided separately from the storage device of the power transaction device 1. The storage unit 16 may be a storage device which is provided outside of the power transaction device 1. The storage unit 16 may be, for example, a hard disc drive (HDD), a solid state drive (SSD), or an electrically erasable programmable read only memory (EEPROM).

### Functions of Terminal Device 7

FIG. 2 is a functional block diagram illustrating an example of a configuration of the terminal device 7 according to the embodiment. The terminal device 7 includes a control unit 71, a display unit 72, an input/output IF 73, a communication unit 74, and a storage unit 75. The functional units of the terminal device 7 can be realized, for example, by causing a CPU of the terminal device 7 to execute a program stored in a storage device or the like. The functional units of the terminal device 7 may be cooperatively realized by software and hardware.

The control unit 71 controls the functional units of the terminal device 7 and manages transmission and reception of data between the functional units of the terminal device 7, processing procedures, and transmission reception of data between the terminal device 7 and another device, and the like.

The display unit 72 presents display information or the like to the user U via a display of the terminal device 7. The display unit 72 can present display details of a DR application to the user U, for example, by executing the DR application installed in advance in the terminal device 7. When a web site or the like provided by the power transaction device 1 or the power supplier device 3 presents the display information to the user U using a general-purpose application program, the display unit 72 may present the display details of the DR application to the user U using software such as a browser.

The display unit 72 can display DR plan information and assist with inputting of input information by the user U. For example, the display unit 72 may display a transaction price per unit wattage in the present or future, a current cumulative remuneration, and a three-dimensional model of a street received from the power transaction device 1. The display unit 72 may display a graphical user interface (GUI) or the like and receive various input operations from the user U. The display of the terminal device 7 includes a liquid crystal display (LCD) or an organic electroluminescence (EL) display.

The input/output IF 73 transmits an input operation from the user U to the functional units of the terminal device 7 and presents information from the functional units of the terminal device 7 to the user U. A part of the function of the input/output IF 73 may be shared by a part of the function of the display unit 72. The input/output IF 73 includes, for example, a mouse, a track ball, a touch panel, a keyboard, and a speaker.

The communication unit 74 performs data communication between the terminal device 7 and another device by wired communication or wireless communication. The communication unit 74 transmits or receives power transaction information to and between the power transaction device 1, the power supplier device 3, the charging/discharging device 5, and/or the vehicle M and the terminal device 7.

The storage unit 75 stores power transaction information transmitted or received by the terminal device 7. The storage unit 75 stores a DR application AP. The storage unit 75 may store information such as an operation schedule of the user U. For example, the operation schedule may include information indicating that the user U goes out with the vehicle M from February 12 in 2025 to February 15 in 2025. The storage unit 75 may be a part of the storage device provided in the terminal device 7 or may be a storage device which is provided separately from the storage device of the terminal device 7. The storage unit 75 may be, for example, an HDD, an SSD, or an EEPROM.

### Example of Power Transaction Information

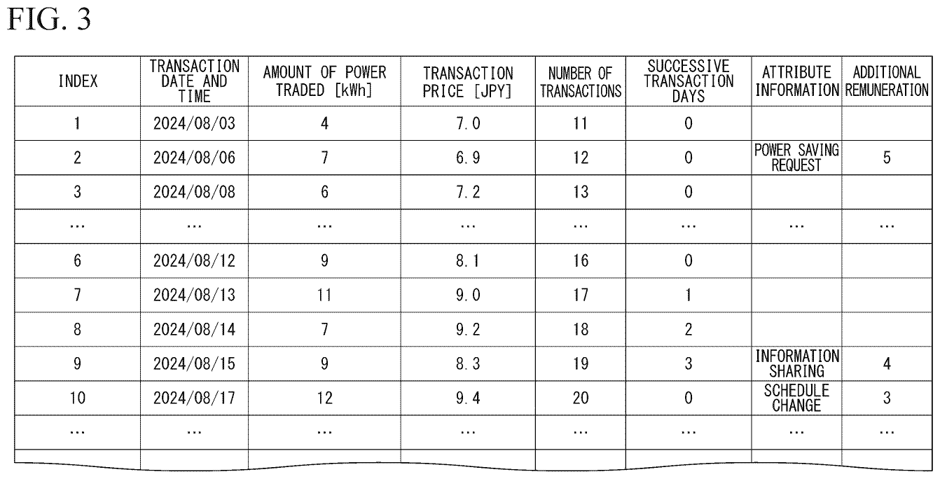

FIG. 3 is a diagram illustrating an example of power transaction information according to the embodiment. The power transaction information includes, for example, a power transaction date and time, an amount of power traded, a transaction price, the number of transactions, successive transaction days, attribute information, and additional remuneration.

An index is a number which is added to one power transaction. The power transaction date and time indicates a date and time at which a power transaction has been performed. For example, when the user U discharged power from the battery B and sold power between 10:20 AM and 11:30 AM on August 3 in 2024, the power transaction date and time is recorded as “10:20 AM on August 3 in 2024 to 11:30 AM on August 3 in 2024.” In the example illustrated in FIG. 3, for the purpose of simplification of explanation, the power transaction date and time is simply described as “August 3 in 2024.”

The amount of power traded indicates an amount of power traded in one power transaction. For example, when the user U sold an amount of power 4 kWh on August 3 in 2024 (corresponding to index 1), the amount of power traded is recorded as “4.” In the example illustrated in FIG. 3, only a case in which the power transaction in the power transaction information is selling is described for the purpose of simplification of explanation, but the power transaction may include buying. For example, by adding a minus sign to the amount of power traded when the power transaction is selling, the case in which the power transaction is selling and the case in which the power transaction is buying may be distinguished.

The transaction price indicates a transaction price per unit wattage in one power transaction. For example, in the transaction on August 3 in 2024 (corresponding to the transaction of index 1), the transaction price is 7.0 yen. The number of transactions indicates the number of times the user U has performed the power transaction. For example, in the transaction on August 3 in 2024 (corresponding to the transaction of index 1), the number of transactions indicates that the user U performs an eleventh power transaction.

The number of successive transaction days indicates the number of days in which the user U has successively performed the power transaction. For example, there a day on which a power transaction has not been performed between the transaction on August 3 in 2024 (corresponding to the transaction of index 1) and the transaction on August 6 in 2024 (corresponding to the transaction of index 2). Accordingly, the number of successive transaction days is “0” in the transaction on August 6 in 2024. On the other hand, in the transaction on August 15 in 2024 (corresponding to the transaction of index 9), the power transaction has been successively performed in three days from the transaction on August 12 in 2024 (corresponding to the transaction of index 6). Accordingly, the number of successive transaction days is “3” in the transaction on August 15 in 2024. An additional remuneration may be added when the number of successive transaction days is equal to or greater than a determined number of days, for example, an additional remuneration “1” may be added to the user U every 3 days.

The attribute information is information indicating that there is a power saving request, a power selling request, or a power buying request from a country, a local government, an administrative organization, a corporation aggregate, a general company such as a special wholesale supplier, a power company, or the like and is information which is added when the user U has performed an operation in response to the request. For example, when the user U has sold power in response to a power saving request from the power company, the attribute information may be recorded as “power saving request” (corresponding to the transaction of index 2). When the user U has changed a previously determined schedule in response to the request like the transaction on August 17 in 2024 (corresponding to the transaction of index 10), the attribute information may be recorded as “schedule changed.” When the user U has not been aware of the request, the attribute information may be added.

The additional remuneration is a remuneration associated with the attribute information and is, for example, a remuneration which is given when the user U has performed an operation in response to the request. When the user U has performed an operation in response to the power saving request like the transaction on August 6 in 2024 (corresponding to the transaction of index 2), an additional remuneration “5” is given to the user U. When the user U has performed an operation in response to a request and when other users share that the user U participates in the DR plan, an additional remuneration may also be given to the user U. For example, when the user U shares the transaction on August 15 in 2024 (corresponding to the transaction of index 9) with other users, an additional remuneration is given to the user U via the DR application. When other users have performed a power transaction with sharing of a transaction or the like from the user U, an additional remuneration may be given to the user U. The additional remuneration may increase according to the amount of power traded in the power transactions of the other users and the number of other users having performed a power transaction.

### Process Flow

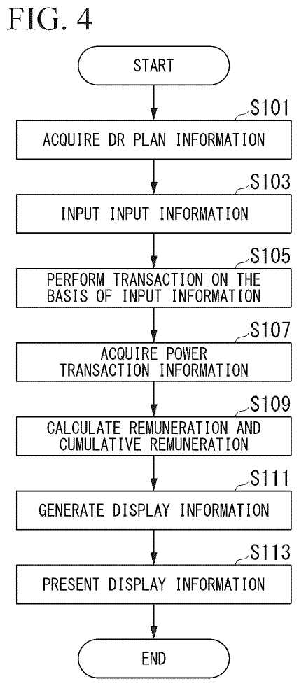

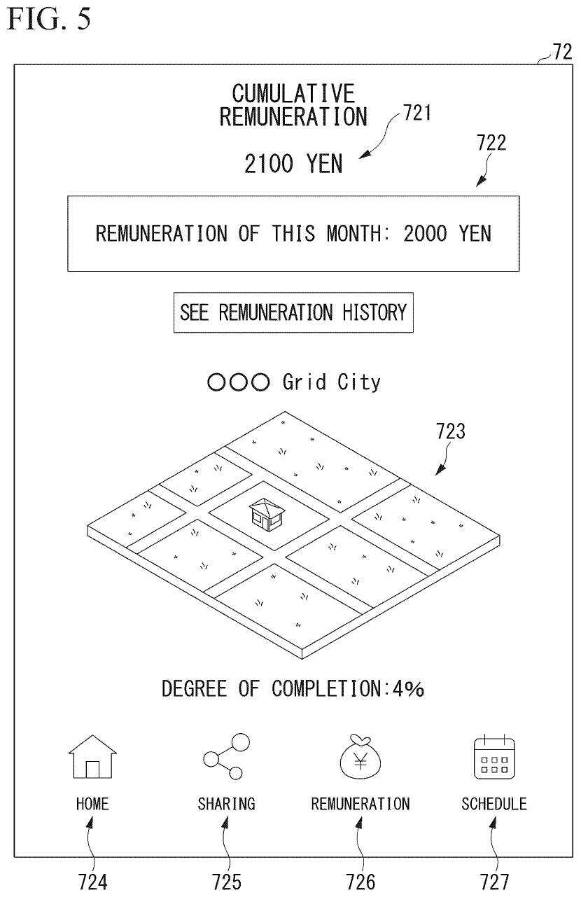

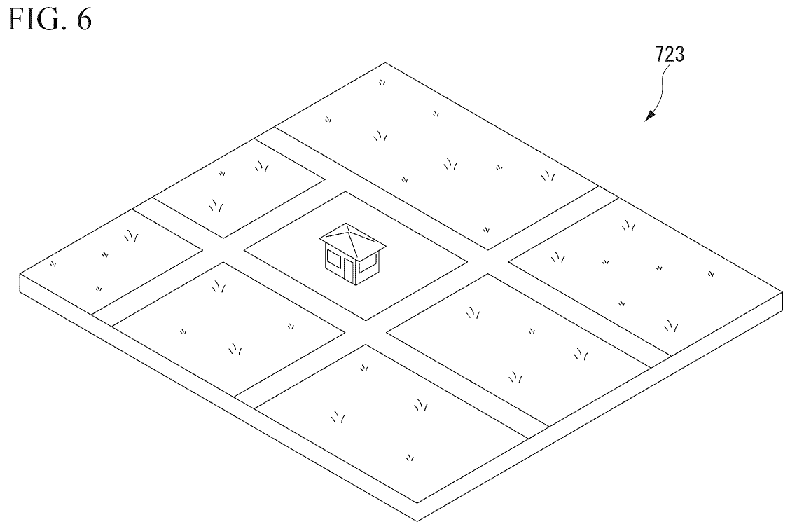

FIG. 4 is a flowchart illustrating an example of a process flow in the power transaction system S according to the embodiment. FIG. 5 is a diagram illustrating an example of display information displayed on the terminal device 7 according to the embodiment. FIGS. 6, 7, 8, and 9 are diagrams illustrating an example of a change of the display information displayed on the terminal device 7 according to the embodiment. The process flow illustrated in FIG. 4 starts, for example, when the user U has operated the terminal device 7 to start the DR application AP.

When the user U operates the terminal device 7 to start the DR application, the DR application acquires DR plan information (Step S101). FIG. 5 illustrates an example of a GUI which is displayed on the display by the display unit 72 of the terminal device 7. For example, the DR application may display a cumulative remuneration 721 acquired to up now by the user U, a remuneration 722 acquired in this month by the user U, and a three-dimensional model of a street 723 in the GUI. The DR application may display a home icon 724, a sharing icon 725, a remuneration icon 726, and a schedule icon 727 in the GUI.

When the three-dimensional model of a street 723 is pushed, the three-dimensional model of a street 723 can be enlarged or reduced and displayed on the display. When the user U pushes the sharing icon 725, the three-dimensional model of a street 723 or the like can be shared by other users. When the user U pushes the remuneration icon 726, the cumulative remuneration 721 and the remuneration 722 acquired in this month are displayed in the GUI, and the user U can ascertain the remuneration. When the user U pushes the schedule icon 727, the schedule of the user U and the calendar are displayed in the GUI, and the user U can change or delete a registered schedule by registering the schedule in the calendar. The user U may refer to the calendar for the DR plan information in the future.

The user U inputs input information to the GUI of the terminal device 7 with reference to the DR plan information (Step S103). For example, the user U may input the input information indicating that power is to be sold with reference to the attribute information indicating that there is a power saving request from a country, a local government, an administrative organization, a corporation aggregate, a general company such as a special wholesale supplier, a power company, or the like. When the user U sells power in response to the power saving request, for example, “power saving request” is recorded in the attribute information as shown in the transaction of index 2 in FIG. 3. When the user U inputs the input information indicating that an amount of power 7 kWh is to be sold, “7” is recorded in the amount of power traded.

The user U transmits the input information from the terminal device 7 to the power transaction device 1, and the power transaction device 1 receives the input information. The power transaction device 1 communicates with the power supplier device 3 and the charging/discharging device 5 and performs a power transaction on the basis of the input information (Step S105). For example, when the user U has input the input information indicating that an amount of power 7 kWh is to be sold in the transaction on August 6 in 2024 (corresponding to the transaction of index 2), the power transaction device 1 transmits a control instruction to discharge power of “7 kWh” from the battery B to the charging/discharging device 5. The charging/discharging device 5 discharges power of “7 kWh” from the battery B in accordance with the control instruction. Alternatively, the user U may input the input information indicating that power is to be discharged from the battery B between a certain time and another time. Here, the charging/discharging device 5 may control charging and discharging of the battery B such that the residual capacity of the battery B is equal to or greater than a predetermined value. The input information may include information for designating an amount of power charged or discharged, a date and time of charging or discharging, or the like and information for designating charging or discharging based on the attribute information. For example, when the vehicle M is connected to the charging/discharging device 5, the input information may include information indicating that charging or discharging is performed in accordance with a DR plan.

When the power transaction performed in Step S105 ends, the acquisition unit 12 acquires power transaction information based on results of the power transaction from the power supplier device 3, the charging/discharging device 5, and the terminal device 7 (Step S107). For example, when the user U has traded an amount of power “7 kWh” in the transaction on August 6 in 2024 (corresponding to the transaction of index 2), the acquisition unit 12 acquires the amount of power traded, the transaction price, and the attribute information.

The calculation unit 13 calculates a remuneration and a cumulative remuneration with reference to the input information received from the terminal device 7 and the power transaction information on the performed power transaction (Step S109). For example, the calculation unit 13 calculates the remuneration by multiplying the amount of power traded and the transaction price. The calculation unit 13 calculates the cumulative remuneration on the basis of the past power transaction information of the user U. The cumulative remuneration may include a remuneration obtained by the user U by selling power in the power transaction and a remuneration corresponding to a discount obtained by the user U by buying power in the power transaction. The calculation unit 13 may sum the remuneration obtained by the user U by selling power in the power transaction and the remuneration obtained by the user U by buying power in the power transaction and calculate a total power transaction price. The calculation unit 13 may count the number of times the user U has participated in the DR plan as the number of transactions. For example, when the days in which the user has participated in the DR plan are successive such as the transactions from August 12 in 2024 to August 15 in 2024 (corresponding to the transactions of indices 6 to 9), the calculation unit 13 may count the successive transaction days. The calculation unit 13 stores the power transaction information in the storage unit 16.

The display control unit 14 generates display information on the basis of the power transaction information and the remuneration and the cumulative remuneration calculated by the calculation unit 13 (Step S111). The display control unit 14 generates some or all of contents included in the GUI to be displayed on the display unit 72 as illustrated in FIG. 5. For example, the display control unit 14 generates a display field of the cumulative remuneration 721 and a display field of the remuneration acquired in this month 722. The display control unit 14 generates the three-dimensional model of a street 723. The display control unit 14 may generate the home icon 724, the sharing icon 725, the remuneration icon 726, and the schedule icon 727. The display unit 72 of the terminal device 7 may generate the home icon 724, the sharing icon 725, the remuneration icon 726, and the schedule icon 727. When the user U participates in the DR plan and acquires a remuneration, an animation for adding the remuneration calculated by the calculation unit 13 may be displayed in the display field of the remuneration acquired in this month 722. For example, “2,000 yen +240 yen” may be displayed in the display field of the remuneration acquired in this month 722. Alternatively, an animation rising from the remuneration acquired in this month 722 to a value obtained by summing the remuneration acquired in this month 722 and the remuneration calculated by the calculation unit 13 may be displayed.

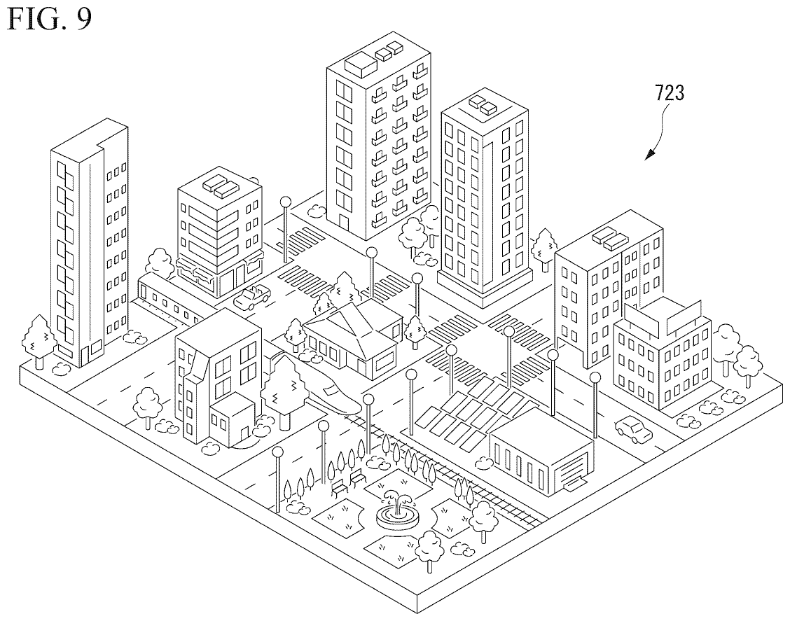

The display control unit 14 generates the three-dimensional model of a street 723 on the basis of the cumulative remuneration 721 and the power transaction information. For example, the three-dimensional model of a street 723 may be developed by 1% of the degree of completion (100%) of the three-dimensional model of a street 723 illustrated in FIG. 9 whenever the user U participates four times in the DR plan, and the appearance of the three-dimensional model of a street 723 may change whenever the three-dimensional model of a street 723 is developed by 4%. For example, the three-dimensional model of a street 723 may be developed by 1% whenever the cumulative remuneration 721 increases by 500 yen, and the appearance of the three-dimensional model of a street 723 may change whenever the three-dimensional model of a street 723 is developed by 4%. Alternatively, the three-dimensional model of a street 723 may be generated on the basis of values obtained by applying different weights to the cumulative remuneration 721, the number of transactions, the number of successive transaction days, and the additional remuneration. For example, the display control unit 14 may apply a first weight to the number of transactions, the number of successive transaction days, and the additional remuneration, apply a second weight to the cumulative remuneration 721, and generate the three-dimensional model of a street 723. Alternatively, the display control unit 14 may use the total power transaction price calculated by the calculation unit 13 instead of the cumulative remuneration 721. That is, the three-dimensional model of a street 723 is developed according to a degree of participation of the user U in the DR plan or a result of participation of the user U in the DR plan. The degree of participation in the DR plan may not necessarily accompany a power transaction. For example, when the user U has prepared for discharging power from the battery B of the vehicle M according to the DR plan but the DP plan has been paused or stopped, it may be considered that the user U has participated in the DR plan. The “weight” may also be referred to as a “contribution rate,” a “significance,” or a “proportion.” For example, when a value obtained by dividing a weight which is a sum value of a plurality of weights is used as the “weight,” the value can be referred to as a “contribution rate,” a “significance,” or a “proportion.”

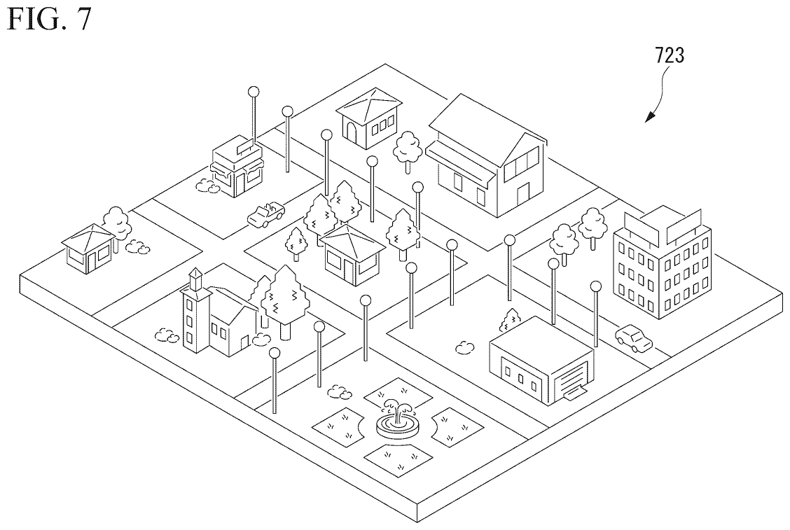

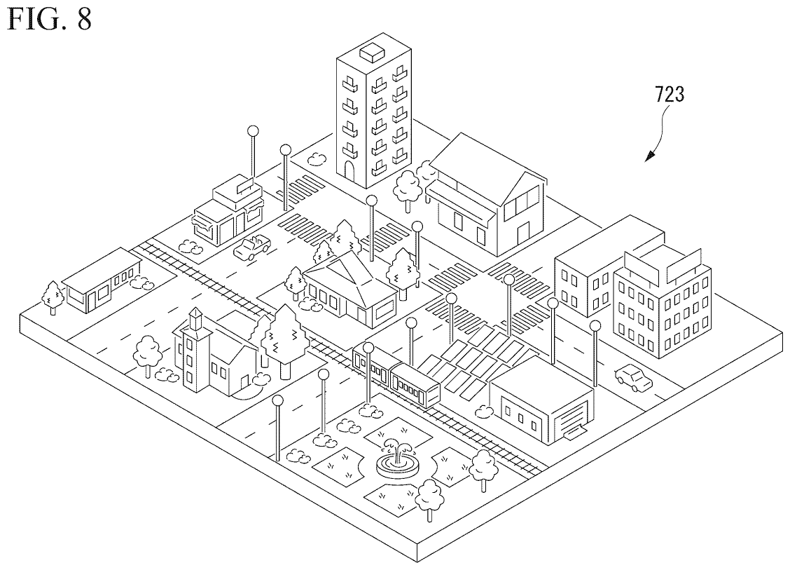

FIGS. 6, 7, 8, and 9 illustrate an example of the three-dimensional model of a street 723 generated by the display control unit 14 and illustrate a part of the display information displayed on the terminal device 7. The three-dimensional model of a street 723 illustrated in FIG. 6 is, for example, a three-dimensional model in which the degree of completion of a street is 4%. When the user U participates in the DR plan, the three-dimensional model of a street 723 is developed like the three-dimensional model of a street 723 illustrated in FIG. 7. The degree of completion of the three-dimensional model of a street 723 illustrated in FIG. 7 is, for example, 24%. Whenever the user U participates in the DR plan and gains good results, the degree of completion of the three-dimensional model of a street 723 increases. For example, the degree of completion of the three-dimensional model of a street 723 illustrated in FIG. 8 is 72%, and the degree of completion of the three-dimensional model of a street 723 illustrated in FIG. 9 is 100%. Development of the three-dimensional model of a street 723 may be expressed by an expression method other than the expression method of improving modern buildings. For example, the expression method may include improving a green belt or improving water quality. The display control unit 14 transmits the generated display information to the terminal device 7 via the communication unit 15.

When the terminal device 7 receives the display information, the display unit 72 presents the display information to the user U (Step S113). The display unit 72 displays the GUI illustrated in FIG. 5 on the display of the terminal device 7 and presents the cumulative remuneration 721, the remuneration acquired in this month 722, the three-dimensional model of a street 723, and the degree of completion of the three-dimensional model of a street 723 to the user U. The user U can share the cumulative remuneration 721, the remuneration acquired in this month 722, or the three-dimensional model of a street 723 with other users by pushing the sharing icon 25. The user U can refer to details of the remuneration by pushing the remuneration icon 726. The user U can refer to information of the DR plan, the weather forecast, or the like in the future by inputting and referring to the schedule of the user U by pushing the schedule icon 727. As a result, the process flow of the flowchart ends.

With the power transaction system S according to the embodiment described above, it is possible to visualize a user's operation results in power transactions associated with DR. With the power transaction system S, it is possible to visualize a user's operation results on the basis of the power transaction information in addition to the cumulative remuneration. With the power transaction system S, it is possible to continuously motivate a user to participate in a power transaction associated with DR.

In the three-dimensional model of a street 723, elements of a street may be individually designated and developed by the user U. For example, elements of a street include a building, a structure, a vehicle, an aircraft, a plant, and an animal, and a size, a shape, a color, a number, a type, and emitted sound of each element may change with development of the three-dimensional model of a street 723. That is, the three-dimensional model of a street 723 includes one or more objects as illustrated in FIGS. 6 to 9, and the object can grow or develop in a stepwise manner to represent the degree of participation of the user U in a power transaction and/or the cumulative remuneration.

While a mode for carrying out the present invention has been described above in conjunction with an embodiment, the present invention is not limited to the embodiment, and various modifications and substitutions can be applied without departing from the gist of the invention.

What is claimed is:

1. A power transaction system comprising:
an acquisition unit configured to acquire power transaction information indicating a user's power transaction;
a calculation unit configured to calculate a cumulative remuneration on the basis of the power transaction information; and
a display control unit configured to generate display information on the basis of a degree of participation in the power transaction based on the power transaction information and the cumulative remuneration and to transmit the display information to the user's terminal,
wherein the display information includes a graphical object, and
wherein the terminal presents the display information to the user.

2. The power transaction system according to claim 1, wherein the power transaction information includes the number of transactions,
wherein the degree of participation is calculated on the basis of the number of transactions, and
wherein the display information changes according to the degree of participation.

3. The power transaction system according to claim 2, wherein the power transaction information further includes at least one of a transaction date and time, an amount of power traded, a transaction price per unit wattage, successive transaction days, attribute information, and additional remuneration, and
wherein the display information changes according to the power transaction information.

4. The power transaction system according to claim 1, wherein the display information is generated on the basis of the degree of participation multiplied by a first weight and the cumulative remuneration multiplied by a second weight, and
wherein the first weight is different from the second weight.

5. The power transaction system according to claim 3, wherein the attribute information includes information indicating whether the user's operation schedule has changed on the basis of the power transaction, and
wherein a predetermined value is added to the additional remuneration when the operation schedule has changed.

6. The power transaction system according to claim 3, wherein the attribute information includes a request from at least one of a country, a local government, an administrative organization, a corporation aggregate, a general company, and a power company, and
wherein a predetermined value is added to the additional remuneration when the user has performed the power transaction in response to the request.

7. The power transaction system according to claim 3, wherein a predetermined value is added to the additional remuneration when the number of successive transaction days is equal to or greater than a predetermined number of days.

8. The power transaction system according to claim 3, wherein a predetermined value is added to the additional remuneration according to the number of other users when the user shares the display information with the other users.

9. The power transaction system according to claim 8, wherein another predetermined value is added to the additional remuneration when the other users have performed a power transaction on the basis of the display information from the user.

10. The power transaction system according to claim 1, wherein the object expresses the degree of participation or the cumulative remuneration in a stepwise manner.

11. The power transaction system according to claim 10, wherein the object includes at least one of a building, a structure, a vehicle, an aircraft, a plant, and an animal, and
wherein at least one of a size, a shape, a color, a number, a type, and emitted sound of the object changes on the basis of the degree of participation or the cumulative remuneration.

12. A power transaction method comprising:
an acquisition step of acquiring power transaction information indicating a user's power transaction;
a calculation step of calculating a cumulative remuneration on the basis of the power transaction information; and
a display control step of generating display information on the basis of a degree of participation in the power transaction based on the power transaction information and the cumulative remuneration and transmitting the display information to the user's terminal,
wherein the display information includes a graphical object, and
wherein the terminal presents the display information to the user.
